(19) United States
(12) Patent Application Publication
(10) Pub. No.: US 2007/0202943 A1
(43) Pub. Date: Aug. 30, 2007

(54) Symbol Driven Contributions For A Prize Pool In A Wagering Game

(76) Inventor: Alfred Thomas, Las Vegas, NV (US)

Correspondence Address: NIXON PEABODY LLP, 161 N. CLARK STREET, 48TH FLOOR, CHICAGO, IL, 60601-3213, US

(21) Appl. No.: 10/594,803

(22) PCT Filed: Mar. 18, 2005
(86) PCT No.: PCT/US05/09181

§ 371 Date: Sep. 28, 2006

Related U.S. Application Data
(60) Provisional application No. 60/558,222, filed on Mar. 31, 2004.

(51) Int. Cl. G06F 19/00

(52) U.S. Cl. 463/27

(57) ABSTRACT

A gaming terminal and a method for playing a wagering game on the gaming terminal. The gaming terminal is one of a plurality of gambling terminals and the wagering game has a prize pool. The method includes conducting a basic game having a randomly selected outcome. A player is awarded at payout amount if the randomly selected outcome is one of a plurality of winning outcomes. Also, the amount of the prize pool is increased if the randomly selected outcome is a prize-pool increasing outcome. In one embodiment, the only payout amounts available at the gaming terminal are from the bonus pool that is funded by the prize-pool increasing outcome.

### FIELD OF THE INVENTION

The present invention relates generally to gaming terminals and, more particularly, to a gaming terminal and a gaming terminal network having an enhanced prize pool.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “secondary” or “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In existing progressive jackpots, the progressives are often high-pay, low-frequency progressives, which may result in some players becoming disheartened when they do not win. Also, because the progressive jackpots are increased by a percentage of the coin-in, the jackpot may not rise very quickly. Because the jackpots increase as a percentage of coin-in, the rate of the increase of the jackpot does not vary depending on the outcome or the result of the game.

In most existing gaming machines, when a player achieves a non-winning outcome, the player's wager input is lost to the player, although the player may have received some level of entertainment in the exchange for the wager input. Obviously, players at gaming machines would prefer to avoid outcomes in which they believe the wager input has been entirely lost. To the extent that this impression of a “lost” wager input can be minimized, the overall level of player excitement will increase and the player will tend to remain at the gaming terminal longer with the belief that they may be able to win back their wager.

One method of increasing the player satisfaction is achieved by the wagering game PIGGY BANKIN'®. In this game, a stand-alone machine has a prize pool that increases by one credit when one certain non-winning combination of symbols (i. e., three blanks) is achieved. However, this game only allows for one combination to add a set amount to the prize pool, which is not very satisfying to the player. Also, because it is a stand-alone machine, the player does not have the excitement of playing in a multi-terminal gaming environment with bigger pots (or prize pools).

Another prior method of reducing the feeling of a “lost” wager is to have a particular, non-winning symbol combination, i.e., three blanks, result in a return of a player's wager. However, this yields too small of a return and the player does not feel as though they have “won” anything.

Thus, there is a need for increasing player excitement by improving wagering game formats that minimize the feeling of a “lost” wager input and by other methods of providing high-frequency jackpots, such as prize pools, that rise in dollar amount quickly. There is also a need for a game where the prize pool receives contributions that can vary dependent upon the outcome of the game.

### SUMMARY OF THE INVENTION

The present invention satisfies the needs mentioned above by allowing the player another chance to recover all or portions of lost wager inputs when certain non-winning outcomes are achieved. The present invention does so by providing a unique wagering game with a prize pool that increases more rapidly by adding to the prize pool a portion or all of the wager input (or more than the wager input) when the player achieves one or more outcomes, which can be winning or non-winning outcomes. As such, the player believes that he or she still has the chance of recovering that lost wager input if he or she wins the prize pool. Because the present invention relies on certain outcomes in the wagering game to fund the prize pool, the present invention is much different from traditional progressive games that automatically allocates a portion of each wager input to the progressive jackpot, regardless of the outcome of the wager game.

In accordance with one embodiment of the present invention, there is provided a gaming terminal and a method for playing a wagering game on the gaming terminal, the gaming terminal being one of a plurality of gaming terminals and the wagering game having a prize pool. The method includes conducting a basic game having a randomly selected outcome. A player is awarded a payout amount if the randomly selected outcome is one of a plurality of winning outcomes. Also, the amount of the prize pool is increased if the randomly selected outcome is a prize-pool increasing outcome. In one embodiment, the only payout amounts available at the gaming terminal are from the bonus pool that is funded by the prize-pool increasing outcome.

In accordance with another embodiment of the present invention, there is provided a gaming system having a controller and a plurality of gaming terminals coupled to the controller. Each of the plurality of gaming terminals has a wagering game with a randomly selected outcome and is linked to a plurality of prize pools. In response to the randomly selected outcome, at any of the plurality of gaming terminals, being one of a plurality of prize-pool increasing outcomes, the controller increases one of the plurality of prize pools. Also, in response to the randomly selected outcome at any of the gaming terminals being one of a plurality of prize-pool award outcomes, the controller awards a player one of the prize pools.

In accordance with some embodiments of the present invention, multiple symbol combinations result in a contribution being made to a single prize pool. In some embodiments, these multiple symbol contributions can result in the single prize pool being increased by differing amounts.

The above summary of the present invention is not intended to represent each embodiment, or every aspect, of the present invention. The detailed description and figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIG. 3 is a gaming system of two sets of interconnected video gaming terminals and signage according to one embodiment of the present invention.

FIG. 4a is an illustration of a pay table on the gaming terminal of FIG. 1.

FIG. 4b is an illustration of a pay table according to another embodiment of the present invention.

FIGS. 5a and 5b are illustrations of a bonus game according to one embodiment of the present invention.

FIG. 6 is a flowchart describing the operation of the gaming terminal of FIGS. 1 and 2.

FIG. 7 illustrates one embodiment for a network that is useful for conducting the enhanced basic games in accordance with the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

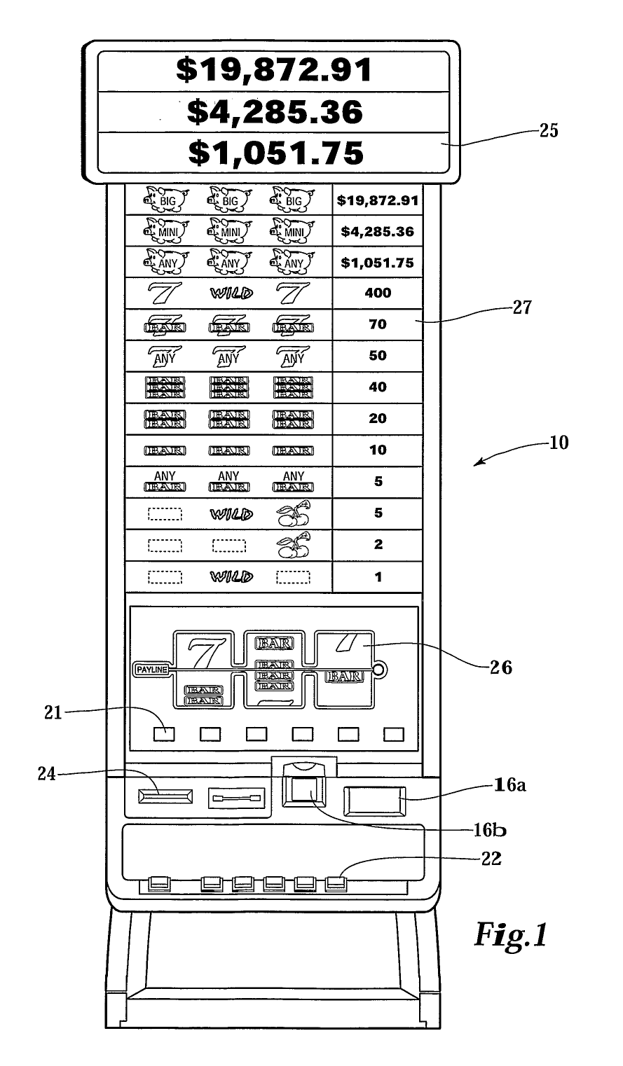

FIG. 1 shows a perspective view of a typical gaining terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and a player-identification card reader 24. For outputs, the gaming terminal 10 includes a prize pool game display 25 for displaying the value of a prize pool, or, as in this embodiment a variety of prize pools, a main display 26 for displaying information about the basic wagering game, and a secondary display 27 that displays an electronic version of a pay table, and also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes a touch screen 21 overlaying the entire monitor (or a portion thereof) to allow players to make game-related selections. Alternatively, the gaming terminal 10 may have a number of mechanical reels to display the game outcome.

The player-identification card reader 24 allows for the identification of a player by reading a card with information indicating his or her true identity. Currently, the identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The gaming terminal 10 may use the secondary display 27 for providing the player with information about his or her account or other player-specific information.

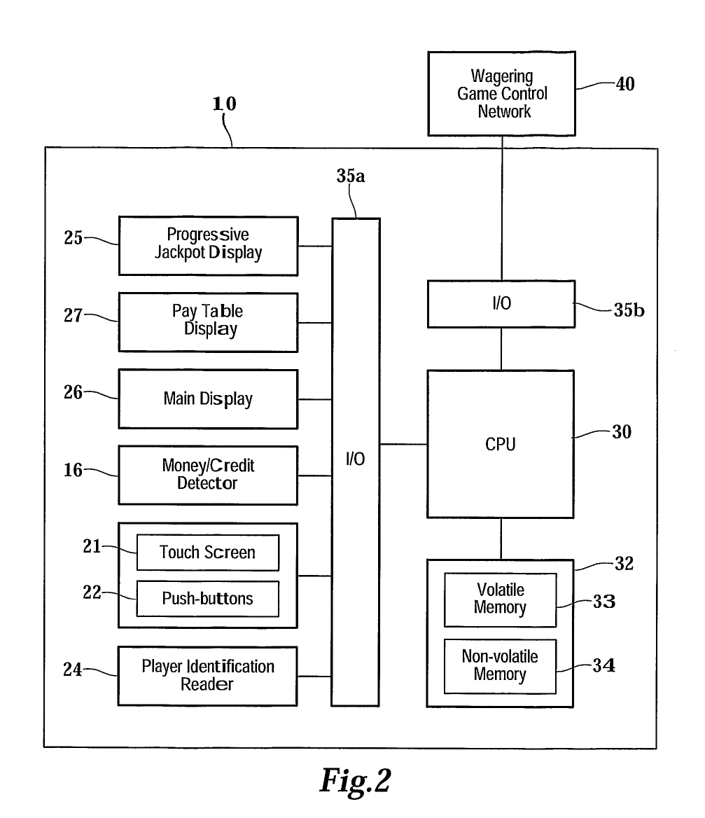

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a system memory 32. The system memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

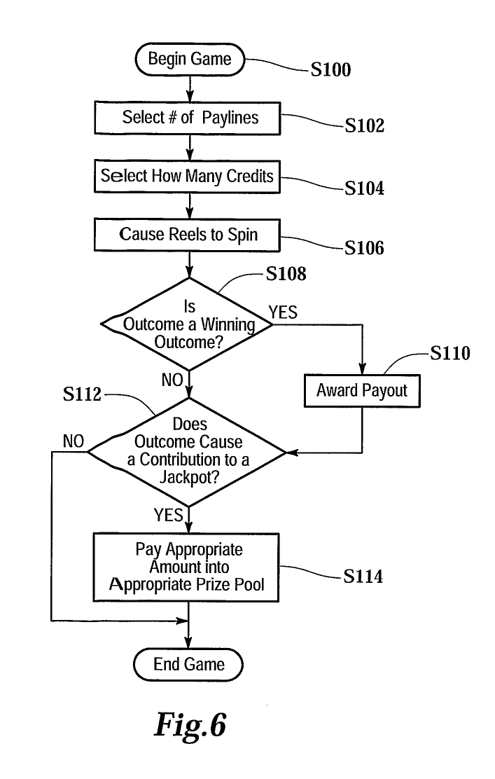

As will be discussed in more detail below with respect to FIG. 6, the gaming terminal 10 is typically operated as part of a game control network 40 having control circuitry and memory devices, such as a network that controls the play of restricted-access progressive wagering games, as described in U.S. patent application Ser. No. 60/502,762, filed on Sep. 12, 2003, and entitled “Restricted Access Progressive Game For A Gaming Machine,” which is commonly owned and herein incorporated by reference in its entirety. The gaming terminal 10 often has multiple serial ports, each port dedicated to providing data to a specific host computer system that performs a specific function (e.g., accounting, player-tracking, or a progressive game control system, etc). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the advantages of the RS-485 capability (e.g., multi-drop capability that allows many gaming terminals 10 to communicate with the game control network 40). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection.

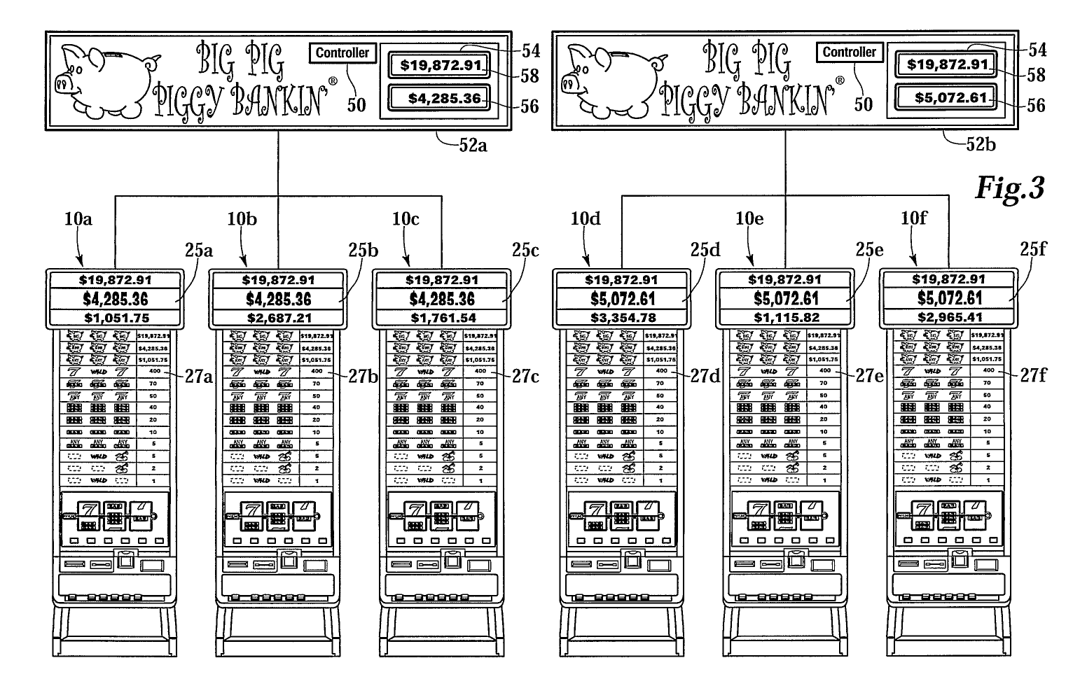

FIG. 3 shows two banks of gaming terminals 10a-10c and 10d-10f. In this embodiment, the two banks are linked to each other via a wide-area network. The discussion that follows will relate to only the first bank, but is equally applicable to the second bank as well. The gaming terminals 10a-10c of the first bank are interconnected and linked to a single wagering game controller 50. The wagering game controller 50 can be linked to a bank (e.g., three or four adjacent gaming terminals) of gaming terminals 10a-10c, a large number of gaming terminals 10 within a casino (such as both banks 10a-10c and 10d-10f), or gaming terminals 10 located at several casinos (see FIG. 6 below). The first bank of gaming terminals 10a-10c are all located under signage 52. The signage 52 includes at least one prize pool display 54, displaying a plurality of dollar amounts for a multi-terminal prize pool.

The wagering game controller 50 controls the functions related to a prize pool game that is being conducted at the gaming terminals 10a-10c. This includes receiving wager-input signals from the gaming terminals 10a-10c, resulting in an increase in the prize pool or prize pools. The wagering game controller 50 also controls the displaying of the amounts of the prize pools on the signage 52, as well as the awarding of a prize pools when a win-prize pool outcome is achieved at one of the gaming terminals 10a-10c.

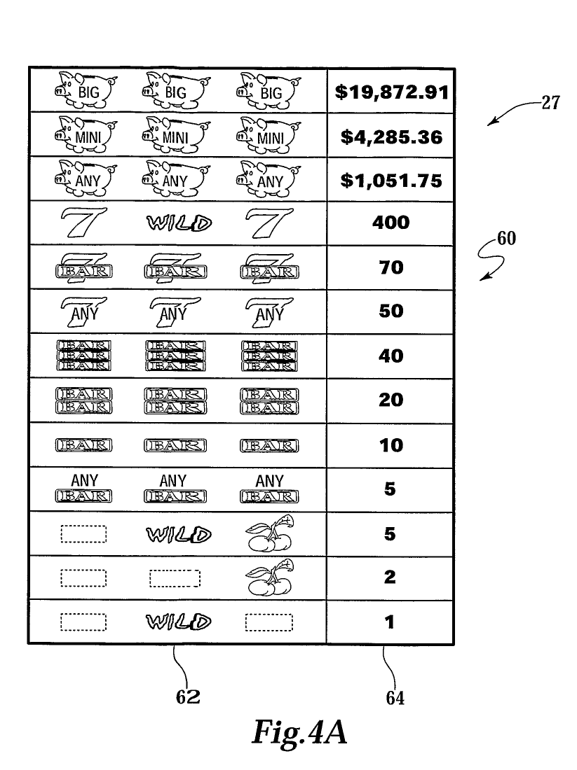

In this embodiment, there are two prize pools shown on the prize pool display 54: a bank prize pool 56 and a wide-area prize pool 58. Each of the gaming terminals 10a-10c are capable of competing for the multi-terminal prize pools as shown in the signage 52. Also, each terminal has its own terminal-level prize pool that is shown in the prize pool displays 25a-25c. In this embodiment, the prize pool displays 25a-25c also show the wide-area prize pool and the bank prize pool. The terminal-level prize pool is unique to every terminal 10a, 10b, 10c, and only activities at that particular gaming terminal 10a, 10b, 10c are used to increase the value of the terminal-level prize pool. In this embodiment, each terminal 10a-10c is competing for its own terminal-level prize pool as shown in the prize pool display 25a-25c. Also, the three gaming terminals 10a-10c in the first bank are part of a bank of terminals and are competing for the single bank prize pool shown in the displays 25a-25c and the display 56 The three terminals 10a-10c are also competing against other terminals in the casino, as shown in the second bank of terminals 10d-10f or over a wide-area network (See FIG. 6) for the wide-area prize pool shown in displays 25a-c and display 58. These three prize pools are achieved when the randomly selected outcome is a symbol combination that includes a “PIG” symbol, as shown by the top three symbol combinations in FIGS. 4a and 4b.

Additionally, and relevant to the present invention, the gaming terminals 10a-10c are competing for ten different basic-game winning outcomes shown below the three prize pool outcomes (i.e., “PIG” symbol combinations) in the pay table on the secondary displays 27a-27c and in FIGS. 4a and 4b.

Further, the gaming terminals 10a-c of the first bank can lack the CPU 30 (FIG. 2) such that the wager-related processing and the random outcome selections for all the gaming terminals 10a-10c are performed by the wagering game controller 50. In essence, the gaming terminals 10a-10c are simply input stations for receiving inputs from the players and output stations for displaying the pay tables and randomly selected outcomes. In these embodiments, the wagering game controller 50 executes the game program that allows for the randomly selected outcomes of the basic games being conducted in each of the gaming terminals 10a-10d. The wagering game controller 50 also performs all of the functions of the CPU 30 as described above in FIG. 2.

While FIG. 3 has been described in conjunction with a wagering game controller 50 receiving, evaluating, and apportioning the collective wager inputs, the present invention contemplates a single gaming terminal 10a performing these functions as the “master” gaming terminal 10a. Furthermore, in some embodiments, there may be a controller 50 associated with each bank, each wide-area network, or any combination of banks within a casino or wide-area network.

Turning now to FIG. 4a, a pay table 60, as displayed on secondary display 27, will be described. The pay table 60 illustrates to players of the gaming machines 10a-c the winning combination of symbols and how many credits the player is awarded for achieving a winning outcome. The pay table 60 includes a first column 62 indicating some of the possible outcomes that can be randomly selected during the basic game. The outcomes in the pay table 60 include winning outcomes for the basic game (the outcomes listed in the fourth through thirteenth rows of the first column 62). There are also non-winning outcomes, which will be described below. The outcomes in the pay table 60 also include winning outcomes for the prize pools, which are the top three outcomes, each of which includes three “PIG” symbols.

A second column 64 of the pay table 60 defines the amount that the player is awarded in a basic game for achieving one of these winning outcomes. This outcome may be a set amount or it may be variable, as will be described below.

During the play of the game, certain symbol combinations contribute an award amount to the three jackpots shown. The amount contributed may be a set percentage of the amount wagered (e.g., 20% of the total wager amount), or it may be a set credit amount (e.g., $1 or 1 credit), as shown in FIGS. 4a and 4b.

In the preferred embodiment, the prize pools are increased whenever the player achieves a prize-pool triggering symbol, such as “money in the bank” or “pay the bank,” on any of the reels. The symbol could cause the same amount (e.g., three credits) to go into each of the three prize pools, or it could trigger different amounts to be credited into each prize pool (e.g., three credits into the terminal-level jackpot, two credits into the bank jackpot, and one credit into the wide-area jackpot).

In another embodiment, the prize-pool triggering symbol, when combined with another symbol, may cause an amount to be credited only to one particular prize pool. For example, when the prize-pool triggering symbol is achieved with a seven symbol, a particular number of credits (or percentage of the amount wagered) may be awarded to the terminal-level prize pool.

In one embodiment, the gaming terminal 10 will only increase the terminal-level prize pool when a non-winning outcome (as shown in the pay table of FIG. 4b) is achieved. By increasing the prize pool when the player has a non-winning or “losing” outcome, the player will feel as though there is a chance of earning the wager back. In such an embodiment, the terminal-level prize pool is the only prize pool that is increased—because this is the one that the player feels that they are most likely to win—and it is increased by a percentage of the wager amount. Although, in another embodiment, a set amount (e.g., 5 credits) may be added to the terminal-level prize pool, regardless of the wager amount. In the preferred embodiment, multiple non-winning combinations can result in an increase in the prize pool. Each combination may increase the prize pool by different amounts.

In some embodiments, the amounts of the multi-terminal prize pools may also be increased when one of the gaming terminals 10a-10c displays a particular outcome. Just as described above, certain symbol combinations will trigger the increasing of the “community” prize pools (as shown in FIG. 4b). When any player is a part of that community (bank or wide-area network) achieves this combination, all of the terminals in that community register the increase. In other alternatives, one symbol combination may cause an increase in all three prize pools (as shown in FIG. 4b). In other embodiments, certain symbol combinations may increase only one of the prize pools. For example, two single-bar symbols in combination with any other symbol may increase the terminal-level prize pool; two double-bar symbols in combination with any other symbol may increase the bank prize pool; and two triple-bar symbols in combination with any other symbol may increase the wide-area prize pool.

In some embodiments, the amount that the particular (whether terminal or multi-level) prize pool is increased may be the entire wager amount placed by the player, or the amount of increase may even exceed the amount of the wager placed by the player. For example, some combinations may cause a multiplier (e.g., 2 or 3) to be applied. This causes the prize pool to increase rapidly, and provides the player with greater incentives to continue playing the wagering game. Such an increase is not possible with a progressive game. Because the progressive game automatically deducts a fixed percentage from the input wager, it is not possible to continuously be deducting an amount greater than the input.

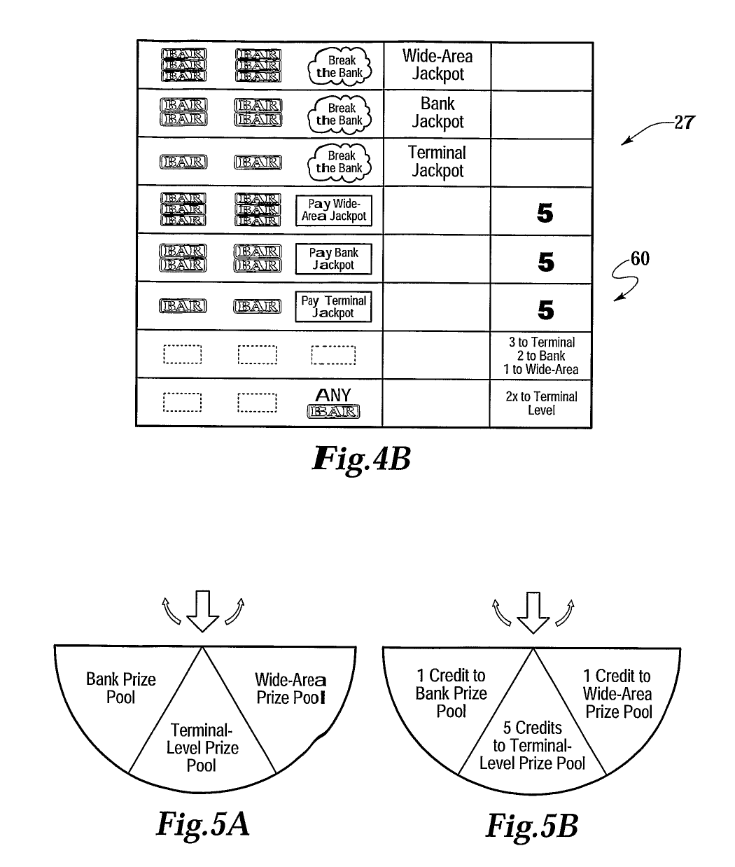

In other embodiments, the amount that the prize pool is increased may be randomly determined after the prize-pool increasing symbol combination is achieved. For example, if the prize-pool increasing symbol combination is three bars, the amount the prize pool is increased may be any amount between one to five credits. Alternatively, if it is an embodiment that includes multiple prize pools, which prize pool is increased may be randomly determined (as shown in FIG. 5a).

In another embodiment, the amount that the prize pool is increased may be unknown to the player. In this embodiment, the signage may not illustrate that a prize pool is increased, but there would not be a numerical representation of how much the pool is increased. Instead, there is a visual representation on the gaming terminal of the increase. For example, there may be a display showing a piggy bank, with the piggy bank increasing in size each time the prize pool is added to. The piggy bank would keep increasing in size, without the player knowing exactly how much is in there until a “break the bank” symbol combination is achieved, at which point the bank would visually break, and the player would be awarded the amount in the prize pool.

The prize pool can be won if one of the highest level symbol combinations is achieved in the basic game. For example, as shown in the pay table 60 in FIGS. 4a and 4b, three different levels of prize pools are awarded, the terminal-level prize pool, the bank prize pool, and the wide-area prize pool. The combination of three pigs awards the player the wide-area prize pool. As this is the rarest of all combinations, the payout is generally the highest. Next, should the player achieve two pigs and any other symbol, the player is awarded the bank prize pool. Finally, if the player achieves one pig and any two of another symbol, the player is awarded the terminal-level prize pool.

In some embodiments, the combination of symbols may include achieving a “break the bank” symbol on the third reel (FIG. 4b). When a player achieves two of a winning symbol (e.g., cherry, bar, and/or sevens) in combination with a “break the bank” symbol on the third reel, the player is awarded one of the prize pools. In this example, the player would be awarded the terminal-level prize pool if the symbol combination is two single bars and the “break the bank” symbol. If the combination is two double bars and the “break the bank” symbol, then the bank prize pool is awarded. If the symbol combination achieved is two triple bars and the “break the bank” symbol, then the player is awarded the wide-area prize pool.

In other embodiments, the prize pools may be awarded by achieving one or more symbol combinations in the basic game that make the player eligible for a secondary, or bonus game. Then, as part of the bonus game, there is a randomly selected outcome, which may match the three symbol combinations including the pig described in FIG. 4a. Alternatively, the highest winning amount may be the wide-area prize pool, the second highest may be the bank prize pool, and the third highest may be the terminal-level prize pool. The highest (or few highest) winning amount is increased as described above.

In other embodiments, the bonus game may include an external indicator, such as a mechanical arrow, to fluctuate between the multiple prize pools in order to dictate which prize pool the player wins or where contributions are to be made (as shown in FIGS. 5a and 5b).

In yet other embodiments, the only winning combinations (those combinations that award the player credits) are the prize pools (as shown in FIG. 4b). In these embodiments, there are no combinations of symbols that result in a player being awarded a set amount; the amount awarded fluctuates with the prize pools.

Turning now to FIG. 6, the method of funding the prize pool during the basic wagering game will be described. In step s100, a player at the gaming terminal 10 begins a gaming session by any conventional method (e.g., inserting coins or using credits). The gaming terminal 10 has a basic wagering game that involves a player making various inputs, including choosing a number of paylines to play (step s102). In some embodiments, there are a maximum of nine paylines. In other embodiments, there may only be a single payline, as shown in the gaming terminal 10 of FIG. 1. In those embodiments, this step would be skipped. After choosing how many paylines to play, the player selects how many credits (e.g., 1-5) to wager on each payline (s104).

Regarding eligibility for the prize pool, in some embodiments, the player is only eligible for any of the prize pool if the player chooses to play all of the paylines and/or the player wagers the maximum amount on each of the paylines played. In other embodiments, the player is automatically eligible to play for the prize pool, and is not required to make a minimum wager or to play a minimum number of lines. In some other embodiments, there is a “side-wager” option that allows the player to be eligible for the prize pool. The “side-wager” option is described in U.S. patent application Ser. No. 10/659,878, filed on Sep. 11, 2003, entitled “Gaming Machine With Multi-Level Progressive Jackpot,” which is commonly owned and herein incorporated by reference in its entirety.

At step s106, the player begins the basic wagering game, thereby causing the reels to spin and display a symbol combination that corresponds to the randomly selected outcome from the CPU 30 (FIG. 2). At step s108, it is determined if the randomly selected outcome (i.e., arrangement of symbols) is one of the winning outcomes shown in the pay table 60 (FIGS. 4a and 4b). If the answer is “yes,” then the gaming system progresses to step s110, and awards the player with the associated payout amount from the second column 64 of FIGS. 4a and 4b.

If the answer at step s108 is “no,” or, after the payout has been awarded at step s110, then the gaming terminal 10 determines whether the randomly selected outcome matches one of the outcomes associated with causing an increase in one of the prize pools (i.e., if the randomly selected outcome is a prize-pool increasing outcome), as listed in the third column 66 of FIGS. 4a and 4b (s112). If the randomly selected outcome is an outcome that causes an increase in one of the prize pools, then the amount shown in the third column 66 is apportioned to the appropriate prize pool (s114). The game then ends, allowing the player to input more credits for a new session of the wagering game.

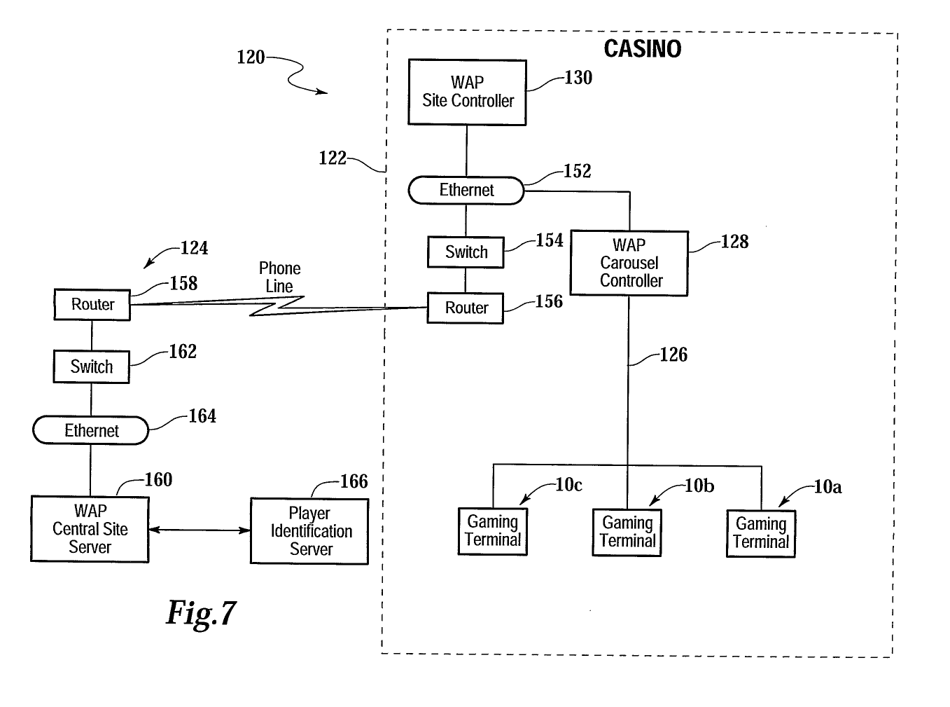

If the terminal-level prize pool is achieved (or any of the multi-terminal prize pools), then that prize pool resets itself to the base amount. In some embodiments, the terminal-level prize pool may be reset after a predetermined amount of time, after a set amount of spins, or when there is a change in players (as described below in reference to FIG. 7). The other prize pools that did not pay out keep increasing until someone wins that prize pool. The prize pools are created by a base amount being put into the pool (e.g., $5 for the terminal-level prize pool, $100 for the bank prize pool, and $1,000 for the wide-area prize pool).

If the randomly selected outcome is one of the outcomes that causes the terminal-level prize pool to be increased, as shown in FIGS. 4 or 4b, the terminal-level prize pool is then increased by a predetermined amount. The predetermined amount may be a percentage of the wager (e.g., 50%) or a set credit amount (e.g., 5 credits). In embodiments where the predetermined amount is a percentage of the wager, it may be that the entire wager amount (100%) is placed back into the terminal-level prize pool. In some embodiments, the contribution may be greater than the wager amount or it may be less than the wager amount.

FIG. 7 illustrates a network 120 that is useful for conducting the restricted-access wagering games that are described above. As used herein, this network 120 will be referred to as the wide-area prize-pool (“WAP”) network 120. In one restricted-access wagering game, only one player is eligible to win a prize pool that is incremented over time based on that player's wagering inputs or when the player achieves a symbol combination resulting in the increase of the prize pool as described above. In another restricted-access wagering game having a prize pool, the game may be only accessible to a group having a limited number of players. In the most fundamental embodiment of a group wagering game, every player in the group is eligible for the prize pool and the prize pool is incremented upwardly from the base value each time one of the players in the group achieves a symbol combination resulting in the increase of the prize pool. The prize pools in the restricted-access wagering games may only be available for a certain amount of time, a certain number of gaming sessions, or when the players are wagering at certain threshold in terms of frequency or wager amounts.

The WAP network 120 typically includes components within a casino 122 and components at a remote location 124. Within the casino 122, a plurality of gaming terminals 10a, 10b, 10c, are connected through a multi-drop serial line 126 to a WAP carousel controller 128. The multi-drop serial line 126 may be, for example, an RS-485 serial data line, which is compatible with and linked to the I/O circuitry 35b (FIG. 2) within the gaming terminal 10. A WAP site controller 130 is connected to the WAP carousel controller 128 through an ethernet connection 152.

To link the WAP site controller 130 to the remote location 124, the casino 122 includes one or more switches 154 and routers 156. The router 156 within the casino 122 is connected through a phone line to a corresponding router 158 at the remote location 124. A WAP central site server 160 at the remote location 124 is coupled to the router 158 through a switch 162 and an ethernet connection 164. The WAP central site server 160 is connected to a player identification server 166 to allow for the exchange of player data and wagering game data stored within the player identification server 166.

In operation, a player identifies himself or herself to the WAP network 120 at the gaming terminal 10a through a player-identification card, an identification card with a single media that is specific to the prize-pool game network, entry of a login name and personal password or pin number, an RFID device, through biometric inputs, or any other method for identifying the player. The player's information is transmitted along the multi-drop serial line 126 and collected by the WAP carousel controller 128. As two of its functions, the WAP carousel controller 128 serves to quickly collect player-identification data from a plurality of gaming terminals 10a, 10b, 10c, and to communicate prize-pool game information to selected ones of the gaming terminals 10a, 10b, 10c, where wagering games are being played.

The player-identification data is collected at the WAP site controller 130 and processed into a format for transmission to the WAP central site server 160 at the remote location 124. After transmission to the WAP central site server 160, the data is compared to existing data within the player identification server 166. The identification of the player at the gaming terminal 10a occurs within the player identification server 166. Further, the player identification server 166 determines which, if any, restricted-access wagering games are associated with the identified player. Information related to the player and the associated restricted-access game is then transmitted to the WAP site controller 130. Based on this information from the remote location 124, the WAP site controller 130, via the WAP carousel controller 128, communicates with the gaming terminal 10a where the player has entered his or her identification information. The WAP site controller 130 is responsible for randomly selecting whether the player has won the individual or group prize pools, incrementing the prize pool(s), awarding the prize pools, and notifying the player of all other information related to the wagering game. In other words, the WAP site controller 130 performs wagering-game functions of the controller 50 of FIG. 3.

After the player has completed the gaming session at the gaming terminal 10a, all information concerning the game play that occurred in the restricted-access wagering game is transmitted from the WAP site controller 130 to the WAP central site server 160. Accordingly, updated player information and game play information regarding the restricted-access wagering game is stored within the player identification server 166. If the player attends a casino different from the casino 122 at a future date and the other casino is linked to the WAP central site server 160, the player can continue playing the updated version of the wagering game at the other casino. In other words, the present invention contemplates that the WAP central site server 160 can be linked to various types of gaming terminals in several casinos so that players can play their group or individual restricted-access wagering games at several different casinos.

The WAP network 120 in FIG. 7 is merely one example of many possible networks that can be developed to support a restricted-access wagering game. Many other types of connections between the gaming terminals 10a, 10b, 10c, and the WAP site controller 130 and between the WAP site controller 130 and the player tracking server 133 can be utilized. Further, the WAP network 120 can be located entirely within the casino 122 and dedicated to only one casino 122, such that it performs all functions related to the restricted-access wagering game within the casino 122. In such an embodiment, all information regarding the player and his or her associated individual or group prize-pool games are stored locally in databases within the casino 122.

In another embodiment, this invention is utilized in a video poker machine. The game is played the same as conventional poker games, however, some of the hands will also correspond to the prize pools, which are also listed in the pay table. As above, if the player ends the round with a hand (combination of cards or symbols) that corresponds to a winning outcome, then the player wins the award associated with that hand. If the player ends the round with a hand that triggers the increase of the terminal-level prize pool, then the terminal-level prize pool is increased by the amount established in the pay table. In the preferred embodiment, only certain non-winning or “losing” hands will cause the terminal-level prize pool to be increased. This is for the reasons stated above: it gives the player the feeling that the entire wager is not lost and that the wager may be redeemed to them in the form of winning the terminal-level prize pool. Furthermore, as above, should the player end the round with a hand corresponding to a prize pool award outcome, then the player wins that prize pool. It should be understood that the video poker machine can include all of the embodiments and variations described above in reference to the slot machine.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A method for playing a wagering game on a gaming terminal, the gaming terminal being one of a plurality of gaming terminals, the plurality of gaming terminals being linked to a multi-terminal prize pool, the method comprising:
conducting a wagering game having a randomly selected outcome;
awarding a player a payout amount in response to the randomly selected outcome being one of a plurality of winning outcomes; and
increasing the amount of the multi-terminal prize pool in response to the randomly selected outcome being a multi-terminal prize-pool increasing outcome.

2. The method of claim 1, wherein the randomly selected outcome comprises a at least one symbol.

3. (canceled)

4. (canceled)

5. The method of claim 1, further including receiving player-identification information, the awarding step comprising crediting an amount to a player account indicated in the player-identification information.

6. (canceled)

7. (canceled)

8. The method of claim 1, wherein the conducting, awarding, and increasing steps are performed by a controller connected to each of the plurality of gaming terminals.

9. The method of claim 1, further comprising inputting a wager amount on the wagering game by the player, and, wherein, in response to the randomly selected outcome being the multi-terminal prize-pool increasing outcome, the multi-terminal prize pool is increased by an amount equal or greater than the wager amount.

10. (canceled)

11. The method of claim 1, further comprising awarding the multi-terminal prize pool in response to the randomly selected outcome being a multi-terminal prize-pool award outcome.

12. The method claim 1, wherein each of the plurality of gaming terminals includes a terminal-level prize pool and further comprising increasing the terminal-level prize pool at one of said plurality of gaming terminals in response to the randomly selected outcome being a terminal-level prize pool at said one of said plurality of gaming terminals.

13. (canceled)

14. The method of claim 12, further comprising awarding the terminal-level prize pool for a limited amount of time or a limited number of gaming sessions.

15. (canceled)

16. The method of claim 1, wherein the multi-terminal prize pool is a restricted-access wagering game.

17. A gaming system, comprising:
a controller; and
a plurality of gaming terminals coupled to the controller, each of the plurality of gaming terminals having a wagering game having a plurality of symbols that indicate a randomly selected outcome of the wagering game, and a prize pool;
in response to one of the randomly selected outcomes at one of the plurality of gaming terminals being one of a plurality of winning outcomes, the one of the plurality of gaming terminals awarding the player a payout amount, and, in response to the randomly selected outcome at one of the plurality of gaming terminals being a prize-pool increase outcome, the one of the plurality of gaming terminals increasing the amount of the prize pool.

18. The gaming system of claim 17, further comprising a plurality of multi-terminal prize pools, the multi-terminal prize pools including a bank-level prize pool and a wide-area network prize pool.

19. The gaming system of claim 18, wherein, in response to the randomly selected outcome being the prize-pool increase outcome, the controller increases the amount of at least one of the plurality of multi-terminal prize pools.

20. The gaming system of claim 17, wherein the prize pool is a terminal-level prize pool.

21. The gaming system of claim 17, wherein the basic game comprises the player wagering a wagering amount on the basic game, and in response to the randomly selected outcome being the prize-pool increase outcome, the prize pool is increased by a percentage of the wager amount.

22. (canceled)

23. (canceled)

24. The gaming system of claim 17, wherein the prize pool is awarded when the randomly selected outcome is a predetermined one of the plurality of winning outcomes.

25. The gaming system of claim 17, wherein the randomly selected outcome comprises at least one symbol and the amount the prize pool is increased depends on which of the at least one symbols is achieved.

26-38. (canceled)

39. A gaming terminal comprising:
a wagering game having a plurality of symbols that indicate a randomly selected outcome of the wagering game; and
a first prize pool;
wherein, in response to the randomly selected outcome being one of a plurality of prize-pool increase outcomes, the gaming terminal increases the amount of the first prize pool.

40. The gaming terminal of claim 39, wherein each of the plurality of prize-pool increase outcomes increases the first prize pool by a different amount.

41. The gaming terminal of claim 39 further comprising:
a second prize pool;
wherein, in response to the randomly selected outcome being one of a plurality of prize-pool increase outcomes, the gaming terminal increases the amount of the first or second prize pools.

42-44. (canceled)

45. The gaming system of claim 17, wherein each of the plurality of winning outcomes includes a plurality of symbols, and at least one of the symbols is a “break the bank” symbol.

46-55. (canceled)
